(19) United States
(12) Patent Application Publication
(10) Pub. No.: US 2007/0099161 A1
(43) Pub. Date: May 3, 2007

(54) Dynamic learning courses

(76) Inventors: Andreas S. Krebs, Karlsruhe (DE); Christian Hochwarth, Wiesloch (DE); Martin Erhard, Karlsruhe (DE)

Correspondence Address: FISH & RICHARDSON, P.C., PO BOX 1022, MINNEAPOLIS, MN, 55440-1022, US

(21) Appl. No.: 11/301,595

(22) Filed: Dec. 13, 2005

Related U.S. Application Data
(60) Provisional application No. 60/732,002, filed on Oct. 31, 2005.

(51) Int. Cl. G09B 3/00; G09B 7/00

(52) U.S. Cl. 434/322; 434/362

(57) ABSTRACT

An example method for dynamic learning courses comprises searching a plurality of learning objects to retrieve a subset of the plurality based on at least one search variable. A first learning object from the subset and a second learning object from the subset are identified. The method then includes dynamically creating a learning course using at least the first and second learning objects.

### RELATED APPLICATION

This application claims the priority under 35 U.S.C. §119 of Provisional Application Ser. No. 60/732,002, filed Oct. 31, 2005.

### TECHNICAL FIELD

This invention relates to learning systems and, more particularly, to creation and management of dynamic learning courses.

### BACKGROUND

Today, an enterprise's survival in local or global markets at least partially depends on the knowledge and competencies of its employees, which may easily be considered a competitive factor for the enterprises (or other organizations). Shorter product life cycles and the speed with which the enterprise can react to changing market requirements are often important factors in competition and ones that underline the importance of being able to convey information on products and services to employees as swiftly as possible. Moreover, enterprise globalization and the resulting international competitive pressure are making rapid global knowledge transfer even more significant. Thus, enterprises are often faced with the challenge of lifelong learning to train a (perhaps globally) distributed workforce, update partners and suppliers about new products and developments, educate apprentices or new hires, or set up new markets. In other words, efficient and targeted learning is a challenge that learners, employees, and employers are equally faced with. But traditional classroom training typically ties up time and resources, takes employees away from their day-to-day tasks, and drives up expenses.

Electronic learning systems provide users with the ability to access course content directly from their computers, without the need for intermediaries such as teachers, tutors, and the like. Such systems have proven attractive for this reason (and perhaps others) and may include a master repository that stores existing versions of learning objects. Such learning objects are typically developed in-house or received from third-party providers to achieve some particular learning objective.

### SUMMARY

This disclosure generally describes systems, methods, and software for dynamically creating and managing electronic learning courses. For example, one method for dynamic learning courses comprises searching a plurality of learning objects to retrieve a subset of the plurality based on at least one search variable. A first learning object from the subset and a second learning object from the subset are identified. The method then includes dynamically creating a learning course using at least the first and second learning objects.

The details of one or more embodiments are set forth in the accompanying drawings and the description below. Features, aspects, and advantages will be apparent from the description, drawings, and claims.

### DESCRIPTION OF DRAWINGS

FIG. 1 is a diagram illustrating an example learning environment according to one embodiment of the present disclosure;

FIG. 2 illustrates an example architecture of a learning management system implemented within the learning environment of FIG. 1;

FIG. 3 illustrates an example content aggregation model in the learning management system;

FIG. 4 is an example of one possible ontology of knowledge types used in the learning management system;

FIG. 5 illustrates an example graphical user interface (GUI) of an authoring environment in the learning management system;

FIGS. 6A-B illustrate an example GUI that allows a learner to dynamically create a learning course;

FIG. 7 is a flow chart illustrating an exemplary method for maintaining metadata associated with learning objects according to one embodiment of the present disclosure; and

FIG. 8 is a flow chart illustrating an exemplary method for dynamically creating a learning course according to one embodiment of the present disclosure.

### DETAILED DESCRIPTION

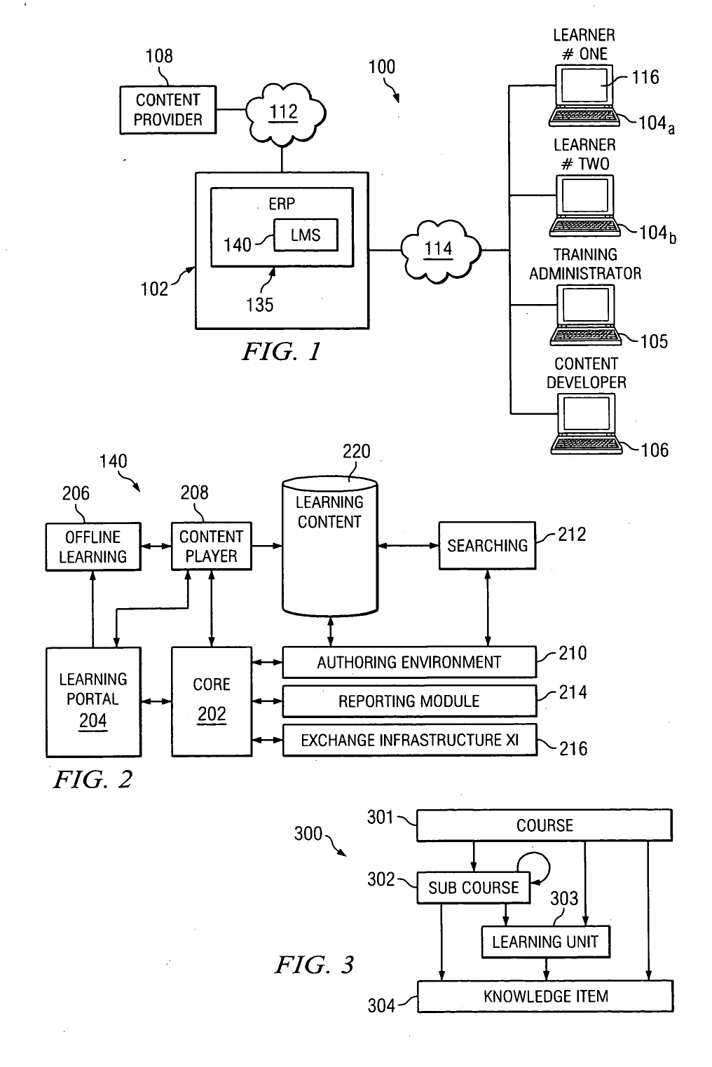

FIG. 1 illustrates an example environment 100 implementing a learning management system 140, which may deliver a blended learning solution of learning methods used in traditional classroom training, web-based training, and virtual classrooms. At a high level, such applications 140 provide convenient information on a learner 104's virtual workplace and at least partially control the learning process itself. The system proposes learning units based on the learner 104's personal data, tracks progress through courses and coordinates the personalized learning experience. In addition, learning management system 140 encompasses the administrative side of the learning platform, where a training administrator 105 structures and updates the offering and distributes it among the target groups. Moreover, the course offering is usually not restricted to internally hosted content. The learning management system 140 often offers robust reporting capabilities, including ad hoc reporting and business intelligence. These capabilities may provide in-depth analysis of the entire business or organization, thereby enabling better decision making. Learning management system 140 also typically helps improve the quality of training and cut costs by reducing the travel and administrative costs associated with classroom training while delivering a consistent learning offering. Training administrators 105 may customize teaching scenarios by using web services to integrate external content, functions, and services into the learning platform from a remote or third party content provider 108.

The training administrator 105 can administer internal and external participants (or learners 104) and enroll them for courses to be delivered via any number of techniques. Training management supports the respective organization, entity, or learner 104 in the day-to-day activities associated with course bookings. Booking activities can be performed by the training administrator in training management on an individual or group participant basis. For example, training administrator 105 can often request, execute, or otherwise manage the following activities in a dynamic participation menu presented in learning management system 140: i) prebook: if participants are interested in taking certain classroom courses or virtual classroom sessions, but there are no suitable dates scheduled, learners 104 can be prebooked for the course types. Prebooking data can be used to support a demand planning process; ii) book: individual or group learners 104 (for example, companies, departments, roles, or other organizational units) can be enrolled for courses that can be delivered using many technologies; iii) rebook: learners 104 can book a course on an earlier or later date than originally booked; iv) replace: learners 104 can be swapped; and v) cancel: course bookings can be canceled, for example, if the learners 104 cannot attend.

Environment 100 is typically a distributed client/server system that spans one or more networks such as external network 112 or internal network 114. In such embodiments, data may be communicated or stored in an encrypted format such as, for example, using the RSA, WEP, or DES encryption algorithms. But environment 100 may be in a dedicated enterprise environment—across a local area network or subnet—or any other suitable environment without departing from the scope of this disclosure. Indeed, while generally described or referenced in terms of an enterprise, the components and techniques may be implemented in any suitable environment, organization, entity, and such. Turning to the illustrated embodiment, environment 100 includes or is communicably coupled with server 102, one or more learners 104 or other users on clients, and network 112. In this embodiment, environment 100 is also communicably coupled with external content provider 108.

Server 102 comprises an electronic computing device operable to receive, transmit, process and store data associated with environment 100. Generally, FIG. 1 provides merely one example of computers that may be used with the disclosure. Each computer is generally intended to encompass any suitable processing device. For example, although FIG. 1 illustrates one server 102 that may be used with the disclosure, environment 100 can be implemented using computers other than servers, as well as a server pool. Indeed, server 102 may be any computer or processing device such as, for example, a blade server, general-purpose personal computer (PC), Macintosh, workstation, Unix-based computer, or any other suitable device. In other words, the present disclosure contemplates computers other than general purpose computers as well as computers without conventional operating systems. Server 102 may be adapted to execute any operating system including Linux, UMX, Windows Server, or any other suitable operating system. According to one embodiment, server 102 may also include or be communicably coupled with a web server and/or a mail server. Server 102 may also be communicably coupled with a remote repository over a portion of network 112. While not illustrated, the repository may be any intra-enterprise, inter-enterprise, regional, nationwide, or other electronic storage facility, data processing center, or archive that allows for one or a plurality of clients (as well as servers 102) to dynamically store data elements, which may include any business, enterprise, application or other transaction data. For example, the repository may be a central database communicably coupled with one or more servers 102 and clients via a virtual private network (VPN), SSH (Secure Shell) tunnel, or other secure network connection. This repository may be physically or logically located at any appropriate location including in one of the example enterprises or off-shore, so long as it remains operable to store information associated with environment 100 and communicate such data to at least a subset of plurality of the clients (perhaps via server 102).

As a possible supplement to or as a portion of this repository, server 102 normally includes some form of local memory. The memory may include any memory or database module and may take the form of volatile or non-volatile memory including, without limitation, magnetic media, optical media, random access memory (RAM), read-only memory (ROM), removable media, or any other suitable local or remote memory component. For example, the memory may store or reference a large volume of information relevant to the planning, management, and follow-up of courses or other content. This example data includes information on i) course details, such as catalog information, dates, prices, capacity, time schedules, assignment of course content, and completion times; ii) personnel resources, such as trainers who are qualified to hold courses; iii) room details, such as addresses, capacity, and equipment; and iv) participant data for internal and external participants. The memory may also include any other appropriate data such as VPN applications or services, firewall policies, a security or access log, print or other reporting files, HTML files or templates, data classes or object interfaces, child software applications or sub-systems, and others. In some embodiments, the memory may store information as one or more tables in a relational database described in terms of SQL statements or scripts. In another embodiment, the memory may store information as various data structures in text files, extensible Markup Language (XML) documents, Virtual Storage Access Method (VSAM) files, flat files, Btrieve files, comma-separated-value (CSV) files, internal variables, or one or more libraries. But any stored information may comprise one table or file or a plurality of tables or files stored on one computer or across a plurality of computers in any appropriate format. Indeed, some or all of the learning or content data may be local or remote without departing from the scope of this disclosure and store any type of appropriate data.

Server 102 also includes one or more processors. Each processor executes instructions and manipulates data to perform the operations of server 102 such as, for example, a central processing unit (CPU), a blade, an application specific integrated circuit (ASIC), or a field-programmable gate array (FPGA). Although this disclosure typically discusses computers in terms of a single processor, multiple processors may be used according to particular needs and reference to one processor is meant to include multiple processors where applicable. In the illustrated embodiment, the processor executes enterprise resource planning (ERP) solution 135, thereby providing organizations with the strategic insight, ability to differentiate, increased productivity, and flexibility they need to succeed. With software such as ERP solution 135, the implementing entity may automate end-to-end processes and extend those processes beyond the particular organization to the entire system by incorporating customers, partners, suppliers, or other entities. For example, ERP solution 135 may include or implement easy-to-use self-services and role-based access to information and services for certain users, thereby possibly boosting productivity and efficiency. In another example, ERP solution 135 may include or implement analytics that enable the particular entity or user to evaluate performance and analyze operations, workforce, and financials on an entity and individual level for strategic and operational insight. ERP solution 135 may further include or implement i) financials to control corporate finance functions while providing support for compliance to rigorous regulatory mandates; ii) operations to support end-to-end logistics for complete business cycles and capabilities that improve product quality, costs, and time to market; and/or iii) corporate services to optimize both centralized and decentralized services for managing real estate, project portfolios, business travel, environment, health and safety, and quality. In the illustrated embodiment, ERP solution 135 also includes or implements some form of human capital management (in this case, learning) to maximize the profitability or other measurable potential of the users, with support for talent management, workforce deployment, and workforce process management. In certain cases, ERP solution 135 may be a composite application that includes, execute, or otherwise implement some or all of the foregoing aspects, which include learning management system 140 as illustrated.

As briefly described above, learning management system 140 is any software operable to provide a comprehensive enterprise learning platform capable of managing and integrating business and learning processes and supporting all methods of learning, not restricted to e-learning or classroom training. As described in more detail in FIG. 2, learning management system 140 is often fully integrated with ERP solution 135 and includes an intuitive learning portal and a powerful training and learning management system, as well as content authoring, structuring, and management capabilities. Learning management system 140 offers back-office functionality for competency management and comprehensive assessment for performance management, and offers strong analytical capabilities, including support for ad hoc reporting. The solution uses a comprehensive learning approach to deliver knowledge to all stakeholders, and tailors learning paths to an individual's educational needs and personal learning style. Interactive learning units can be created with a training simulation tool that is also available.

Regardless of the particular implementation, “software” may include software, firmware, wired or programmed hardware, or any combination thereof as appropriate. Indeed, ERP solution 135 may be written or described in any appropriate computer language including C, C++, Java, J#, Visual Basic, assembler, Perl, any suitable version of 4GL, as well as others. For example, returning to the above described composite application, the composite application portions may be implemented as Enterprise Java Beans (EJBs) or the design-time components may have the ability to generate run-time implementations into different platforms, such as J2EE (Java 2 Platform, Enterprise Edition), ABAP (Advanced Business Application Programming) objects, or Microsoft's .NET. It will be understood that while ERP solution 135 is illustrated in FIG. 1 as including one sub-module learning management system 140, ERP solution 135 may include numerous other sub-modules or may instead be a single multi-tasked module that implements the various features and functionality through various objects, methods, or other processes. Further, while illustrated as internal to server 102, one or more processes associated with ERP solution 135 may be stored, referenced, or executed remotely. For example, a portion of ERP solution 135 may be a web service that is remotely called, while another portion of ERP solution 135 may be an interface object bundled for processing at the remote client. Moreover, ERP solution 135 and/or learning management system 140 may be a child or sub-module of another software module or enterprise application (not illustrated) without departing from the scope of this disclosure.

Server 102 may also include an interface for communicating with other computer systems, such as the clients, over networks, such as 112 or 114, in a client-server or other distributed environment. In certain embodiments, server 102 receives data from internal or external senders through the interface for storage in the memory and/or processing by the processor. Generally, the interface comprises logic encoded in software and/or hardware in a suitable combination and operable to communicate with networks 112 or 114. More specifically, the interface may comprise software supporting one or more communications protocols associated with communications network 112 or hardware operable to communicate physical signals.

Network 112 facilitates wireless or wireline communication between computer server 102 and any other local or remote computers, such as clients. Network 112, as well as network 114, facilitates wireless or wireline communication between computer server 102 and any other local or remote computer, such as local or remote clients or a remote content provider 108. While the following is a description of network 112, the description may also apply to network 114, where appropriate. For example, while illustrated as separate networks, network 112 and network 114 may be a continuous network logically divided into various sub-nets or virtual networks without departing from the scope of this disclosure. In some embodiments, network 112 includes access points that are responsible for brokering exchange of information between the clients. As discussed above, access points may comprise conventional access points, wireless security gateways, bridges, wireless switches, sensors, or any other suitable device operable to receive and/or transmit wireless signals. In other words, network 112 encompasses any internal or external network, networks, sub-network, or combination thereof operable to facilitate communications between various computing components in system 100. Network 112 may communicate, for example, Internet Protocol (IP) packets, Frame Relay frames, Asynchronous Transfer Mode (ATM) cells, voice, video, data, and other suitable information between network addresses. Network 112 may include one or more local area networks (LANs), radio access networks (RANs), metropolitan area networks (MANs), wide area networks (WANs), all or a portion of the global computer network known as the Internet, and/or any other communication system or systems at one or more locations. Turning to network 114, as illustrated, it may be all or a portion of an enterprise or secured network. In another example, network 114 may be a VPN between server 102 and a particular client across wireline or wireless links. In certain embodiments, network 114 may be a secure network associated with the enterprise and certain local or remote clients.

Each client is any computing device operable to connect or communicate with server 102 or other portions of the network using any communication link. At a high level, each client includes or executes at least GUI 116 and comprises an electronic computing device operable to receive, transmit, process and store any appropriate data associated with environment 100. It will be understood that there may be any number of clients communicably coupled to server 102. Further, “client” and “learner,” “administrator,” “developer” and “user” may be used interchangeably as appropriate without departing from the scope of this disclosure. Moreover, for ease of illustration, each client is described in terms of being used by one user. But this disclosure contemplates that many users may use one computer or that one user may use multiple computers. As used in this disclosure, the client is intended to encompass a personal computer, touch screen terminal, workstation, network computer, kiosk, wireless data port, smart phone, personal data assistant (PDA), one or more processors within these or other devices, or any other suitable processing device or computer. For example, the client may be a PDA operable to wirelessly connect with external or unsecured network. In another example, the client may comprise a laptop that includes an input device, such as a keypad, touch screen, mouse, or other device that can accept information, and an output device that conveys information associated with the operation of server 102 or other clients, including digital data, visual information, or GUI 116. Both the input device and output device may include fixed or removable storage media such as a magnetic computer disk, CD-ROM, or other suitable media to both receive input from and provide output to users of the clients through the display, namely the client portion of GUI or application interface 116.

GUI 116 comprises a graphical user interface operable to allow the user of the client to interface with at least a portion of environment 100 for any suitable purpose, such as viewing application or other transaction data. Generally, GUI 116 provides the particular user with an efficient and user-friendly presentation of data provided by or communicated within environment 100. As shown in later FIGs, GUI 116 may comprise a plurality of customizable frames or views having interactive fields, pull-down lists, and buttons operated by the user. GUI 116 may be a learning interface allowing the user or learner 104 to search a course catalog, book and cancel course participation, and support individual course planning (e.g., by determining qualification deficits and displaying a learner's completed, started, and planned training activities). Learner 104 also may access and work through web based courses using the learning interface. The learning interface may be used to start a course, reenter a course, exit a course, and take tests. The learning interface also provides messages, notes, and special course offerings to the learner 104. GUI 116 may also be a course editor allowing the content developer to create the structure for the course content, which may be associated with certain metadata. The metadata may be interpreted by a content player of learning management system 140 (described below) to present a course to learner 104 according to a learning strategy selected at run time. In particular, the course editor may enable the author or content developer 106 to classify and describe structural elements, assign attributes to structural elements, assign relations between structural elements, and build a subject-taxonomic course structure. The course editor generates the structure of the course and may include a menu bar, a button bar, a course overview, a dialog box, and work space. The menu bar may include various drop-down menus, such as, for example, file, edit, tools, options, and help. The drop-down menus may include functions, such as create a new course, open an existing course, edit a course, or save a course. The button bar may include a number of buttons. The buttons may be shortcuts to functions in the drop down menus that are used frequently and that activate tools and functions for use with the course editor. The remaining portions of the example course editor interface may be divided in to three primary sections or windows: a course overview, a dialog box, and a workspace. Each of the sections may be provided with horizontal or vertical scroll bars or other means allowing the windows to be sized to fit on different displays while providing access to elements that may not appear in the window.

GUI 116 may also present a plurality of portals or dashboards. For example, GUI 116 may display a portal that allows users to view, create, and manage historical and real-time reports including role-based reporting and such. Generally, historical reports provide critical information on what has happened including static or canned reports that require no input from the user and dynamic reports that quickly gather run-time information to generate the report. Of course, reports may be in any appropriate output format including PDF, HTML, and printable text. Real-time dashboards often provide table and graph information on the current state of the data, which may be supplemented by presentation elements 140. GUI 116 is often configurable, supporting a combination of tables and graphs (bar, line, pie, status dials, etc.), and is able to build real-time dashboards, where presentation elements 140 (as well the displayed application or transaction data) may be relocated, resized, and such. It should be understood that the term graphical user interface may be used in the singular or in the plural to describe one or more graphical user interfaces and each of the displays of a particular graphical user interface. Indeed, reference to GUI 116 may indicate a reference to the front-end or other component of learning management system 140, as well as the particular interface or learning portal accessible via the client, as appropriate, without departing from the scope of this disclosure. In short, GUI 116 contemplates any graphical user interface, such as a generic web browser or touch screen, that processes information in environment 100 and efficiently presents the results to the user. Server 102 can accept data from the client via the web browser (e.g., Microsoft Internet Explorer or Netscape Navigator) and return the appropriate HTML or XML responses to the browser using network 112 or 114, such as those illustrated in subsequent FIGs.

FIG. 2 illustrates one example implementation of learning management system (LMS) 140. In the illustrated embodiment, LMS 140 comprises four example components, namely i) a management system core 202, which controls learning processes and manages and handles the administrative side of training; ii) a learning portal 204, which is the learner's springboard into the learning environment, which allows him to access the course offering and information on personal learning data and learning activities; iii) an authoring environment 210, where learning content and tests are designed and structured; and iv) a content management system 220, where learning content is stored and managed. Generally, LMS 140 is aimed at learners 104, trainers 105, course authors 106 and instructional designers, administrators, and managers.

Learners 104 log on to their personalized learning portal 204 from any suitable client via GUI 116. The learning portal 204 is the user's personalized point of access to the learning-related functions. Generally, learning portal 204 presents details of the complete education and training offering, such as traditional classroom training, e-learning courses (such as virtual classroom sessions or web-based training), or extensive curricula. Self-service applications enable learners 104 to enroll themselves for courses, prebook for classroom courses, and cancel bookings for delivery methods, as well as start self-paced learning units directly. If learner 104 wants to continue learning offline, he can often download the courses onto the client and synchronize the learning progress later. The learning portal 204 may be seamlessly integrated in an enterprise portal, where learner 104 is provided with access to a wide range of functions via one system. Such an enterprise portal may be the learner's single point of entry and may integrate a large number of role-based functions, which are presented to the user in a clear, intuitive structure. The learning portal 204 often gives learner 104 access to functions such as, for example, search for courses using i) find functions: finding courses in the course catalog that have keywords in the course title or description; and ii) extended search functions: using the attributes appended to courses, such as target group, prerequisites, qualifications imparted, or delivery method. Additional functions may include self-service applications for booking courses and canceling bookings, messages and notes, course appraisals, and special (or personalized) course offering including courses prescribed for the learner 104 on the basis of his or her role in the enterprise or the wishes of the respective supervisor or trainer and qualification deficits of learner 104 that can be reduced or eliminated by participating in the relevant courses. The learning portal 204 may also provide a view of current and planned training activities, as well as access to courses booked, including: i) starting a course; ii) reentering an interrupted course; iii) downloading a course and continuing learning offline; iv) going online again with a downloaded course and synchronizing the learning progress; v) exiting a course; and vi) taking a test.

On the basis of the information the learning management system 140 has about learner 104, the learning management system core 202 proposes learning units for the learner 104, monitors the learner's progress, and coordinates the learner's personal learning process. In addition, the learning management system core 202 is often responsible for managing and handling the administrative processes. Targeted knowledge transfer may use precise matching of the learning objectives and qualifications of a learning unit with the learner's level of knowledge. For example, at the start of a course, the management system core 202 may compare learning objectives already attained by the respective learner 104 with the learning objectives of the course. On the basis of this, core 202 determines the learner's current level and the required content and scope of the course. The resulting course is then presented to the learner 104 via a content player 208.

The content player 208 is a virtual teacher that tailors learning content to the needs of the individual learner 104 and helps him navigate through the course; content player 208 then presents the learning course to the learner 104. In certain embodiments, the content player 208 is a Java application that is deployed on a Java runtime environment, such as J2EE. In this case, it is linked with other systems such as a web application server and ERP solution 135 via the Java Connector. The individual course navigation may be set up at runtime on the basis of the learning strategy stored in the learner account. Using the didactical strategies, content player 208 helps ensure that the course is dynamically adapted to the individual learning situation and the preferences expressed by learner 104. At this point, the content player 208 then calculates dynamically adjusted learning paths and presents these to the learner 104—perhaps graphically—to facilitate orientation within a complex subject area. The learner 104 can resume working on an interrupted course at any time. At this point, the content player 208 guides the learner 104 to the spot at which training was interrupted.

Offline learning player 206 generally enables learners 104 to download network or other web-based courses from the learning portal 204 and play them locally. Locally stored courses are listed in the course list with an icon indicating the status of each course. The offline player 206 may guide the learner 104 through the course according to the preferred learning strategy. It may also dynamically adjust the number and sequence of learning objects to the learner's individual learning pattern. If the learner 104 interrupts a course, the offline player 206 reenters the course at the point of interruption the next time. The learner 104 can, at any point in time, resynchronize his offline learning progress with the learning portal 204 and either continue learning online or set the course to a completed status.

LMS core 202 may also include or invoke training management that would be an administrative side of LMS 140. This typically includes course planning and execution, booking and cancellation of course participation, and follow-up processing, including cost settlement. In training management, the training administrator 105 creates the course offering and can, for example, define training measures for individual learners 104 and groups of learners 104. The training administrator 105 creates the course catalog in training management and makes it available (partially or completely) to learners 104 in the learning portal 204 for reference and enrollment purposes. The training administrator 105 can typically administer internal and external participants and enroll them for courses to be delivered using various technologies and techniques. Training management supports numerous business processes involved in the organization, management, and handling of training. Training management can be configured to meet the requirements, work processes, and delivery methods common in the enterprise. Training measures are usually flexibly structured and may include briefings, seminars, workshops, virtual classroom sessions, web-based trainings, external web-based trainings, static web courses, or curricula. Training management includes functions to efficiently create the course offerings. Using course groups to categorize topics by subject area enables flexible structuring of the course catalog. For example, when training administrator 105 creates a new subject area represented by a course group, he can decide whether it should be accessible to learners 104 in the learning portal 202.

Reporting functions 214 in training management enable managers to keep track of learners' learning activities and the associated costs at all times. Supervisors or managers can monitor and steer the learning processes of their employees. They can be notified when their employees request participation or cancellation in courses and can approve or reject these requests. LMS 140 may provide the training manager with extensive support for the planning, organization, and controlling of corporate education and training. Trainers need to have up-to-the-minute, reliable information about their course schedules. There is a wide range of reporting options available in training management to enable the trainer to keep track of participants, rooms, course locations, and so on.

Authoring environment 210 contains tools and wizards that content developers 106 and instructional designers can use to create or import external course content. External authoring tools can be launched directly via authoring environment 210 to create learning content that can be integrated into learning objects and combined to create complete courses (learning nets). Attributes may be appended to content, thereby allowing learners 104 to structure learning content more flexibly depending on the learning strategy they prefer.

Customizable and flexible views allow subject matter experts and instructional designers to configure and personalize the authoring environment 210. To create the HTML pages for the content, the user can easily and seamlessly integrate editors from external providers or other content providers 108 into LMS 140 and launch the editors directly from authoring environment 210. Authoring environment 210 often includes a number of tools for creating, structuring, and publishing course content and tests to facilitate and optimize the work of instructional designers, subject matter experts, and training administrators 105. Authoring environment 210 may contain any number of components or sub-modules such as an instructional design editor is used by instructional designers and subject matter experts to create and structure learning content (learning nets and learning objects), a test author is used by instructional designers and subject matter experts to create web-based tests, and a repository explorer is for training administrators and instructional designers to manage content.

In the illustrated embodiment, course content is stored and managed in content management system 220. Put another way, LMS 140 typically uses the content management system 220 as its content storage location. But a WebDAV (Web-based Distributed Authoring and Versioning) interface (or other HTTP extension) allows integration of other WebDAV-enabled storage facilities as well without departing from the scope of this disclosure. Content authors or developers 106 publish content in the back-end training management system. Links to this content assist the training administrator 105 in retrieving suitable course content when planning web-based courses. A training management component of LMS 140 may help the training administrator 105 plan and create the course offering; manage participation, resources, and courses; and perform reporting. When planning e-learning courses, the training administrator 105 uses references inserted in published courses to retrieve the appropriate content in the content management system for the courses being planned. Content management system 220 may also include or implement content conversion, import, and export functions, allowing easy integration of Sharable Content Object Reference Model (SCORM)-compliant courses from external providers or other content providers 108. Customers can create and save their own templates for the various learning elements (learning objects, tests, and so on) that define structural and content-related specifications. These provide authors with valuable methodological and didactical support.

LMS 140 and its implemented methodology typically structure content so that the content is reusable and flexible. For example, the content structure allows the creator of a course to reuse existing content to create new or additional courses. In addition, the content structure provides flexible content delivery that may be adapted to the learning styles of different learners. E-learning content may be aggregated using a number of structural elements arranged at different aggregation levels. Each higher level structural element may refer to any instances of all structural elements of a lower level. At its lowest level, a structural element refers to content and may not be further divided. According to one implementation shown in FIG. 3, course material 300 may be divided into four structural elements: a course 301, a sub-course 302, a learning unit 303, and a knowledge item 304.

Starting from the lowest level, knowledge items 304 are the basis for the other structural elements and are the building blocks of the course content structure. Each knowledge item 304 may include content that illustrates, explains, practices, or tests an aspect of a thematic area or topic. Knowledge items 304 typically are small in size (i.e., of short duration, e.g., approximately five minutes or less). Any number of attributes may be used to describe a particular knowledge item 304 such as, for example, a name, a type of media, and a type of knowledge. The name may be used by a learning system to identify and locate the content associated with a knowledge item 304. The type of media describes the form of the content that is associated with the knowledge item 304. For example, media types include a presentation type, a communication type, and an interactive type. A presentation media type may include a text, a table, an illustration, a graphic, an image, an animation, an audio clip, and a video clip. A communication media type may include a chat session, a group (e.g., a newsgroup, a team, a class, and a group of peers), an email, a short message service (SMS), and an instant message. An interactive media type may include a computer based training, a simulation, and a test.

Knowledge item 304 also may be described by the attribute of knowledge type. For example, knowledge types include knowledge of orientation, knowledge of action, knowledge of explanation, and knowledge of source/reference. Knowledge types may differ in learning goal and content. For example, knowledge of orientation offers a point of reference to the learner, and, therefore, provides general information for a better understanding of the structure of interrelated structural elements. Each of the knowledge types are described in further detail below.

Knowledge items 304 may be generated using a wide range of technologies, often allowing a browser (including plug-in applications) to be able to interpret and display the appropriate file formats associated with each knowledge item. For example, markup languages (such as HTML, a standard generalized markup language (SGML), a dynamic HTML (DHTML), or XML), JavaScript (a client-side scripting language), and/or Flash may be used to create knowledge items 304. HTML may be used to describe the logical elements and presentation of a document, such as, for example, text, headings, paragraphs, lists, tables, or image references. Flash may be used as a file format for Flash movies and as a plug-in for playing Flash files in a browser. For example, Flash movies using vector and bitmap graphics, animations, transparencies, transitions, MP3 audio files, input forms, and interactions may be used. In addition, Flash allows a pixel-precise positioning of graphical elements to generate impressive and interactive applications for presentation of course material to a learner.

Learning units 303 may be assembled using one or more knowledge items 304 to represent, for example, a distinct, thematically-coherent unit. Consequently, learning units 303 may be considered containers for knowledge items 304 of the same topic. Learning units 303 also may be considered relatively small in size (i.e., duration) though larger than a knowledge item 304.

Sub-courses 302 may be assembled using other sub-courses 302, learning units 303, and/or knowledge items 304. The sub-course 302 may be used to split up an extensive course into several smaller subordinate courses. Sub-courses 302 may be used to build an arbitrarily deep nested structure by referring to other sub-courses 302.

Courses may be assembled from all of the subordinate structural elements including sub-courses 302, learning units 303, and knowledge items 304. To foster maximum reuse, all structural elements should be self-contained and context free.

Structural elements also may be tagged with metadata that is used to support adaptive delivery, reusability, and search/retrieval of content associated with the structural elements. For example, learning object metadata (LOM), per maps defined by the IEEE “Learning Object Metadata Working Group,” may be attached to individual course structure elements. The metadata may be used to indicate learner competencies associated with the structural elements. Other metadata may include a number of knowledge types (e.g., orientation, action, explanation, and resources) that may be used to categorize structural elements.

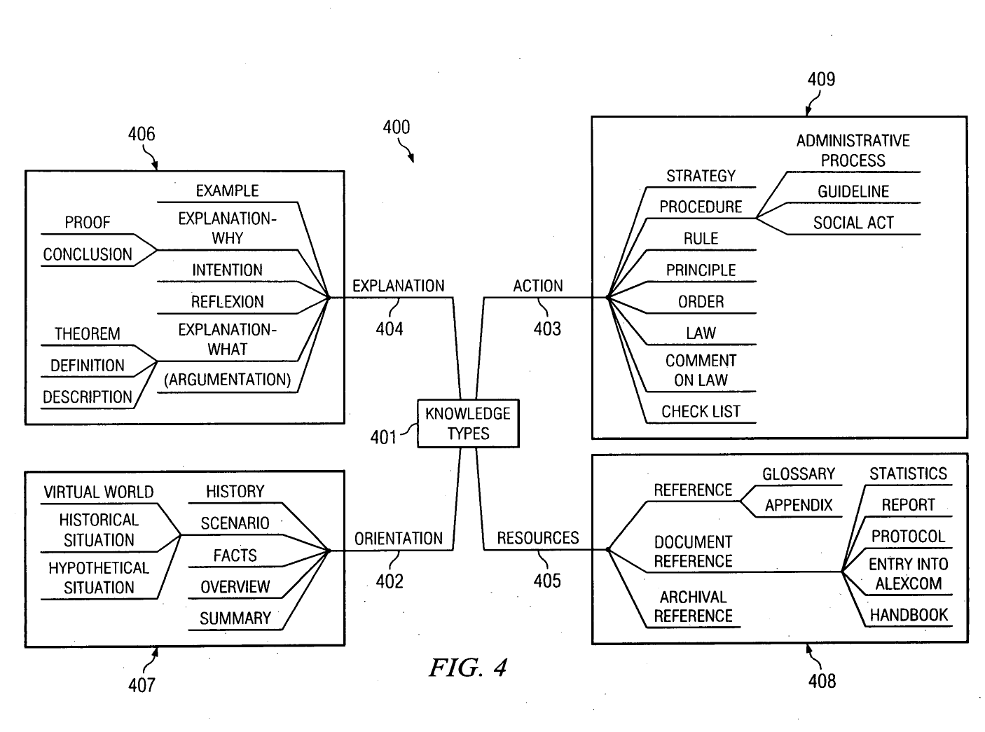

As shown in FIG. 4, structural elements may be categorized using a didactical ontology 400 of knowledge types 401 that includes orientation knowledge 402, action knowledge 403, explanation knowledge 404, and resource knowledge 405. Orientation knowledge 402 helps a learner 104 to find their way through a topic without being able to act in a topic-specific manner and may be referred to as “know what.” Action knowledge 403 helps a learner to acquire topic related skills and may be referred to as “know how.” Explanation knowledge 404 provides a learner with an explanation of why something is the way it is and may be referred to as “know why.” Resource knowledge 405 teaches a learner where to find additional information on a specific topic and may be referred to as “know where.”

The four knowledge types (orientation, action, explanation, and reference) may be further divided into a fine grained ontology. For example, orientation knowledge 402 may refer to sub-types 407 that include a history, a scenario, a fact, an overview, and a summary. Action knowledge 403 may refer to sub-types 409 that include a strategy, a procedure, a rule, a principle, an order, a law, a comment on law, and a checklist. Explanation knowledge 404 may refer to sub-types 406 that include an example, an intention, a reflection, an explanation of why or what, and an argumentation. Resource knowledge 405 may refer to sub-types 408 that include a reference, a document reference, and an archival reference.

Dependencies between structural elements may be described by relations when assembling the structural elements at one aggregation level. A relation may be used to describe the natural, subject-taxonomic relation between the structural elements. A relation may be directional or non-directional. A directional relation may be used to indicate that the relation between structural elements is true only in one direction. Directional relations should be followed. Relations may be divided into two categories: subject-taxonomic and non-subject taxonomic.

Subject-taxonomic relations may be further divided into hierarchical relations and associative relations. Hierarchical relations may be used to express a relation between structural elements that have a relation of subordination or superordination. For example, a hierarchical relation between the knowledge items A and B exists if B is part of A. Hierarchical relations may be divided into two categories: the part/whole relation (i.e., “has part”) and the abstraction relation (i.e., “generalizes”). For example, the part/whole relation “A has part B” describes that B is part of A. The abstraction relation “A generalizes B” implies that B is a specific type of A (e.g., an aircraft generalizes a jet or a jet is a specific type of aircraft).

Associative relations may be used refer to a kind of relation of relevancy between two structural elements. Associative relations may help a learner obtain a better understanding of facts associated with the structural elements. Associative relations describe a manifold relation between two structural elements and are mainly directional (i.e., the relation between structural elements is true only in one direction). Examples of associative relations include “determines,” “side-by-side,” “alternative to,” “opposite to,” “precedes,” “context of,” “process of,” “values,” “means of,” and “affinity.”

The “determines” relation describes a deterministic correlation between A and B (e.g., B causally depends on A). The “side-by-side” relation may be viewed from a spatial, conceptual, theoretical, or ontological perspective (e.g., A side-by-side with B is valid if both knowledge objects are part of a superordinate whole). The side-by-side relation may be subdivided into relations, such as “similar to,” “alternative to,” and “analogous to.” The “opposite to” relation implies that two structural elements are opposite in reference to at least one quality. The “precedes” relation describes a temporal relationship of succession (e.g., A occurs in time before B (and not that A is a prerequisite of B). The “context of” relation describes the factual and situational relationship on a basis of which one of the related structural elements may be derived. An “affinity” between structural elements suggests that there is a close functional correlation between the structural elements (e.g., there is an affinity between books and the act of reading because reading is the main function of books).

Non Subject-Taxonomic relations may include the relations “prerequisite of” and “belongs to.” The “prerequisite of” and the “belongs to” relations do not refer to the subject-taxonomic interrelations of the knowledge to be imparted. Instead, these relations refer to the progression of the course in the learning environment (e.g., as the learner traverses the course). The “prerequisite of” relation is directional whereas the “belongs to” relation is non-directional. Both relations may be used for knowledge items 304 that cannot be further subdivided. For example, if the size of the screen is too small to display the entire content on one page, the page displaying the content may be split into two pages that are connected by the relation “prerequisite of.”

Another type of metadata is competencies. Competencies may be assigned to structural elements, such as, for example, a sub-course 302 or a learning unit 303. The competencies may be used to indicate and evaluate the performance of a learner as learner 104 traverses the course material. A competency may be classified as a cognitive skill, an emotional skill, a senso-motorical skill, or a social skill.

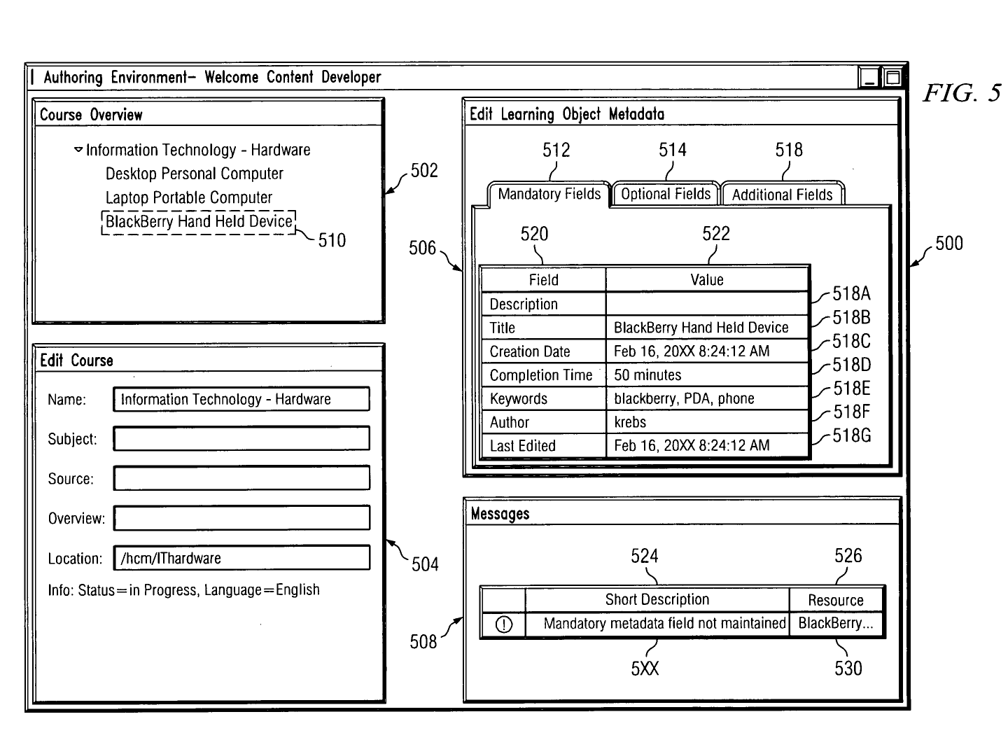

FIG. 5 illustrates an example graphical user interface (GUI) 500 presented by authoring environment 210 (or some other component of, or the whole of, learning management system 140) that allows a content developer 106 to maintain metadata associated with learning objects in LMS 140 according to an embodiment of the invention. As discussed above, learning object is a self-contained, often reusable session that learner 104 may perform or review. Learning objects may be items such as a knowledge item 304, a learning unit 303, or a sub-course 302. Example GUI 500 includes a course overview area 502, an edit course area 504, an edit learning object metadata area 506, and a messages area 508. The course overview area 502 shows a static learning course, Information Technology—Hardware, along with its associated learning objects, including a “BlackBerry Hand Held Device” learning object. This example “BlackBerry” learning object may contain instructions on the operation of a BlackBerry device. The illustrated edit course area 504 shows additional information associated with the Information Technology—Hardware static learning course. Content developer 106 may select a learning object in the course overview area 502, as indicated by the dashed line 510, to view and edit its associated metadata in the edit learning object metadata area 506. GUI 500 also displays messages associated with the metadata of the particular learning object in the messages area 508.

In particular, edit metadata area 506 shows a user interface allowing the metadata for the associated learning object to be maintained. This metadata may include, for example, description, a title, a creation date, an estimated completion time, and one or more key words. The metadata associated with the learning objects allows learner 104 to identify which learning objects are relevant to the learner. The authoring environment 210 may help ensure that that this is possible by requiring at check-in that all learning objects have, for example, certain mandatory metadata and that the metadata is of the correct type. Learner 104 may identify learning objects and initiate the creation of a dynamic learning course that includes the identified learning objects using a GUI as described below. If this metadata is customized or identified as being mandatory, the user interface reports the non-maintenance as an error. On the other hand, if this metadata is customized or identified as being optional, the user interface reports the non-maintenance as a warning. In some implementations, a learning object may only be made available to learners once all metadata corresponding to the mandatory fields is available. Information about the metadata fields, their data type and whether they are mandatory or optional is stored in LMS 140 often on a backend system. The metadata values may be read from a course XML metadata file. To this end, example area 506 displays a mandatory tab strip 512, an optional tab strip 514, and an additional tab strip 516.

The tab strips 512, 514, 516 show fields grouped according to their mandatory indication. For example, the mandatory fields tab 512 contains metadata customized or identified as mandatory. The optional tab 514 contains metadata customized or identified as not mandatory. The additional tab 516 contains metadata values that are not defined in the customizing. For example, this may occur if the customizing is changed or metadata from foreign systems or remote content provider 108 is imported.

In each of the three tabs 512, 514, 516, rows 518A-G represent metadata as customized. A field column 520 contains the language dependent description as entered in the customizing, except for the additional fields tab 516 where the content of a NAME attribute from the metadata file is used, since there is no customizing for this example metadata. The value column 522 contains the value as stored in the metadata file if it is available, otherwise no value normally is normally displayed. The value cells that do not allow input are metadata that the authoring environment 210 automatically maintains and the user (or content developer 106) therefore cannot change.

In the implementation shown here, the mandatory metadata associated with each learning object includes a description 518A, a title 408B, a creation date 508C, a completion time 508D, and keywords 508F. The title 408B of the selected learning object is “BlackBerry.” An average (or estimated) learner 104 should expect to take approximately 50 minutes to complete the learning object. The learning object has the keywords 518E blackberry, PDA, and phone associated with it. The description 508A for the example BlackBerry device learning object is currently empty. The authoring environment 210 notifies the content developer of the missing mandatory metadata using the messages area 508. The messages area 508 includes a short description 524 of any errors that have occurred as well a name of a resource 526 associated with each of the errors. Here, a message 528 indicates that “Mandatory metadata field not maintained” within a learning object 530 beginning with the name “BlackBerry.”

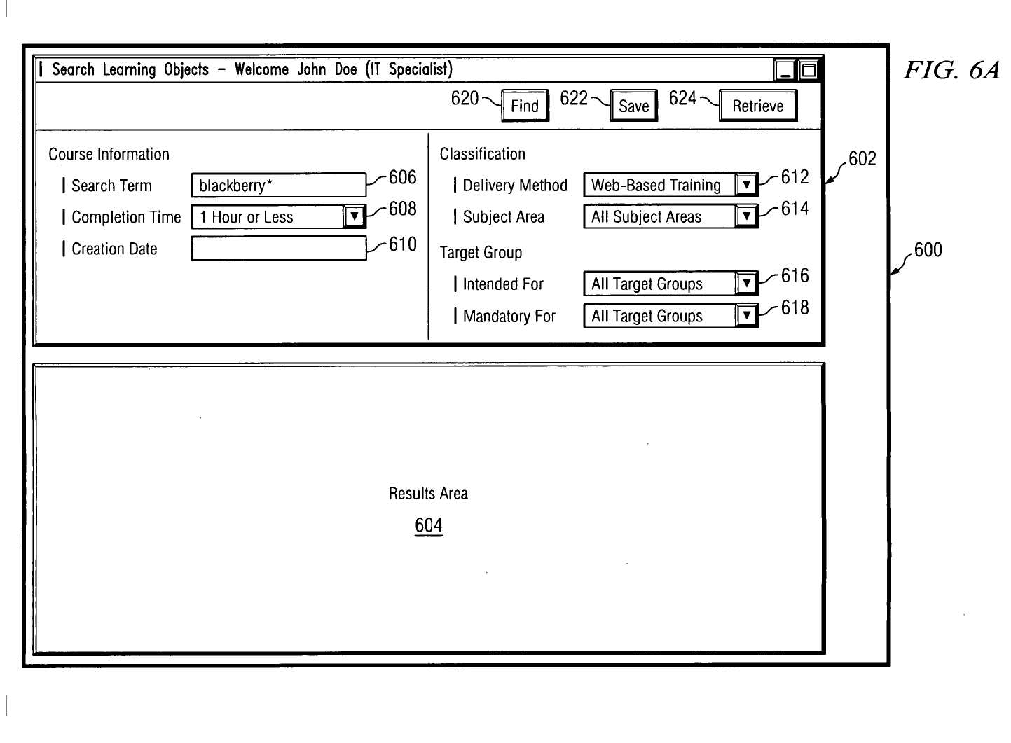

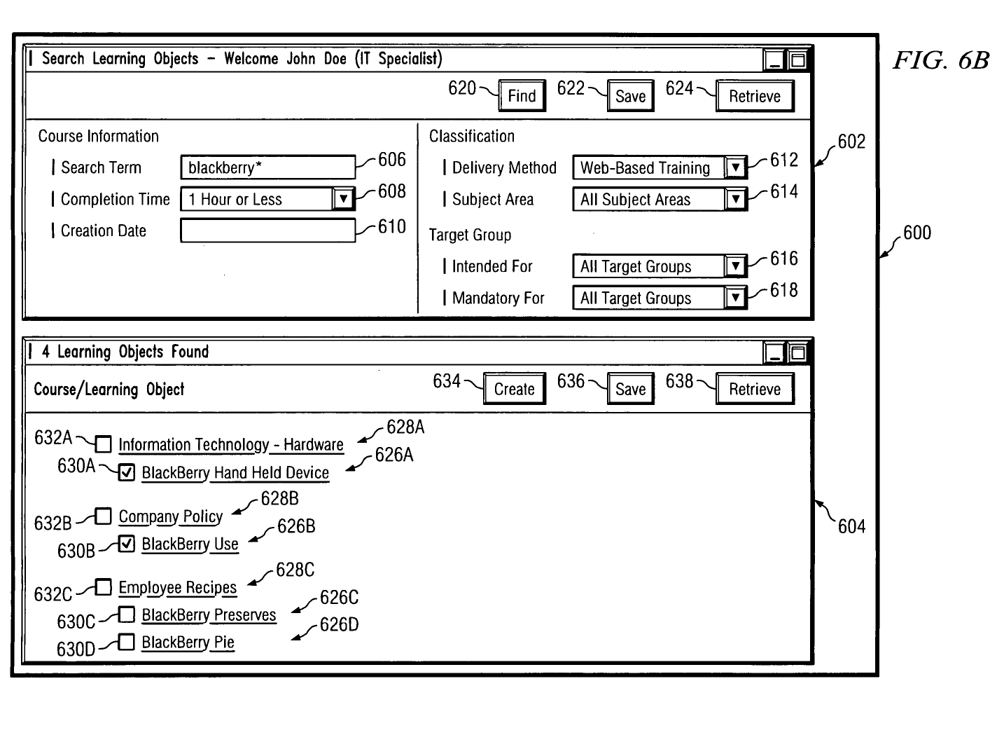

FIGS. 6A-B show a GUI 600 where a learner 104 can identify relevant learning objects and initiate or request the creation of a dynamic learning course. Example GUI 600 includes a search area 602 and a search results area 604. The search area 602 allows learner 104 to specify one or more search variables with which a search of the learning objects is based. The search results area 604 presents the results of the search to leaner 104 and allows him to identify the learning objects relevant to his instructional needs or wants. The search results area 604 also provides an input control that allows learner 104 to initiate the dynamic creation of a learning course that includes at least the identified learning objects.

The search area 602 includes input controls 606-618 that allow the learner to specify various search variables. Of course, the illustrated search variables are for example purposes only and may represent only a subset of the many search variables in a particular implementation. The input controls include a search term 606, a completion time 608, a creation date 610, a delivery method 612, a subject area 614, an intended target group 616, and a mandatory target group 618. Search term variable 606 is a freely editable text field that allows learner 104 to input a search term. The search term entered may be used in a full text search of the plurality of learning objects or a search of the metadata fields, such as the description 518A, the title 518B, and the keywords 518E. The search term may include wild cards, such as an asterisk to denote a variable condition that still satisfies the search term. Here, learner 104 has made the input “blackberry*” indicating that all learning objects having a field that begins with blackberry should be returned. In some implementations, learner 104 may input, in search term variable 606, a phrase in a query language or natural language to be performed on the learning objects or their associated metadata.

The completion time variable 608 allows learner 104 to specify the maximum length of time of requested learning objects, whether individually or in the aggregate. For example, learner 104 may use this field to filter objects based on the time that the learner is willing, or able, to spend studying the particular learning object. Here, the learner has selected “1 Hour or Less” from a pull-down selection list. This example often indicates that only those learning objects estimated to be completed within an hour should be returned in the results list.

The creation date variable 610 allows learner 104 to specify an oldest creation date, such that all of the learning objects returned by the search will have been created on or after the date. For example, this creation date may be a date, such as “last month,” that only pulls objects within the last calendar month or 30 days. Moreover, this pull may be intelligent enough to drop previously identified objects and collect new learning objects based on a change in effective system date. The delivery method variable 612 allows learner 104 to input the mode specifying the delivery technique of the learning object. Here, learner 104 has selected “Web-Based Training” from a pull-down list. Other delivery methods may include options such as live instruction, e-mail delivery, facsimile delivery, postal delivery, and many others. The search area 602 also allows learner 104 to input the subject area 614, intended target group 616, and the mandatory target group 618. In the illustrated example, these variables have defaulted to “All Subject Areas,” “All Target Groups,” and “All Target Groups,” respectively.

In some implementations, search variables may default to a value that is based on a role of the particular learner. Here, the learner is John Doe, an Information Technology (IT) Specialist. The LMS 140 may identify the role of learner 104 using any suitable dynamic or static technique, such as by matching a username input by John Doe during a login operation with an IT Specialist role associated with the username. For example, the learner's username, roles, and associations may be stored in a database within LMS 140 or the learner's roles may be stored in a cookie accessible by the learner's browser. In another example, LMS 140 may identify the learner's role based on policies associate with the user or another logical identifier (such as IP address or sub-net). Such databases, tokens, or policies may be customizable by learner 104, his manager, or an administrator. Returning to the example, LMS 140 may use the IT Specialist role of John Doe to default the mandatory target group variable 618 to a value of “IT Specialist.” In some implementations, LMS 140 may also limit the search of the learning objects based on the learner's role. For example, LMS 140 may remove the “All Target Groups” option from the intended and mandatory target group variables 616 and/or 618. LMS 140 may also remove any other options corresponding to roles with which learner 104 is not associated or established little interest in.

The search area 602 contains input controls find 620, save 622, and retrieve 624, which allow the learner to initiate a search, save a search, and retrieve a saved search, respectively. For example, the save input control 622 may save the search variables as they appear in the search area 602. Later, the retrieve input control 624 may be used to retrieve the saved set of search variables. Activating the retrieve input control 624 may also initiate the search associated with the saved set of search variables.

FIG. 6B shows the GUI 600 after learner 104 has activated the find input control 620. This causes or requests LMS 140 to perform a search of the learning objects using the search variables in the search area 602. The search variables may be compared to content within the learning objects or to metadata associated with the learning objects. LMS 140 then presents the results of the search in the search results area 604. Here, the results of the search include learning objects 626A-D that satisfy the search conditions and static learning courses 628A-C to which the learning objects 626A-D belong. In some implementations, the list of names include hyperlinks that allow learner 104 to review an individual learning object or static learning course presented in the search results area 604.

Example learning objects 626A-D and static learning courses 628A-C have associated selection controls 630A-D and 632A-C, respectively. The selection controls allow the learner to identify the learning objects, as well as entire static learning courses, that are relevant to the needs or wants of learner 104. Learner 104 may make an input in a checkbox to toggle a selection control to a selected state as indicated by a checkmark or a deselected state as indicated by the absence of a checkmark. Returning again to the example illustration, information about the “BlackBerry” device is relevant to this particular learner 104. Here, the learner has selected the “BlackBerry Hand Held Device” learning object 626A and the “BlackBerry Use” learning object 626B. Learning object recipes 626C and 626D involving the blackberry fruit are not relevant to the learner and are deselected, either manually or automatically.

In some implementations, LMS 140 may automatically deselect or remove, from the results list, learning objects or courses that the learner has already completed. In addition, LMS 140 may omit from the list references to a learning object that is already presented as a result of a previous static learning course. For example, the “BlackBerry Hand Held Device” learning object 626A may also be referenced within the “Company Policy” static learning course 628B, but only the first reference to the learning object 626A is presented in the results list. Further, LMS 140 may automatically omit or remove any learning objects that have been completed by the particular learner 104. In this case, LMS 140 may also quickly determine if there is a newer version of the completed object and present the learner 104 with the updated object or the option to select it. Moreover, LMS 140 may merely not retrieve or present any such learning objects instead of removal or deselection.

The search results area 604 also contains input controls create 634, save 636, and retrieve 638. The create input control 634 allows learner 104 to initiate the creation of a dynamic learning course that includes the selected learning objects. LMS 140 creates the course and the content player 208 presents the course to the learner. A list of learning objects may be saved by selecting the save input control 634 and later retrieved by selecting the retrieve input control 638.

The learning objects may be stored within the remote ERP system 135 and a dynamic learning course may be created at a learner system, such as the client, by retrieving the selected learning objects from ERP system 135. If a new version of a learning object is identified, then retrieve input control 638 allows the dynamic learning course to be automatically updated the next time the dynamic learning course is created or used. For example, say learner 104 requests the dynamically creation of a course using a first and second learning object, which he does not complete. At later point, learner 104 may retrieve or request this dynamic course. In this case, LMS 140 or content player 208 may automatically update the first or second learning object, occasionally only if they are not marked as completed, with new versions. In some implementations, the search variables may be saved, so that new learning objects added to the learning content 220 that satisfy the search conditions may automatically be added to the dynamic learning course when the search variables are used again. In the example, say the second learning object is no longer within the saved search parameters (perhaps a time variable). In this case, LMS 140 could automatically drop the second learning object and replace it with any newly available or qualifying learning objects.

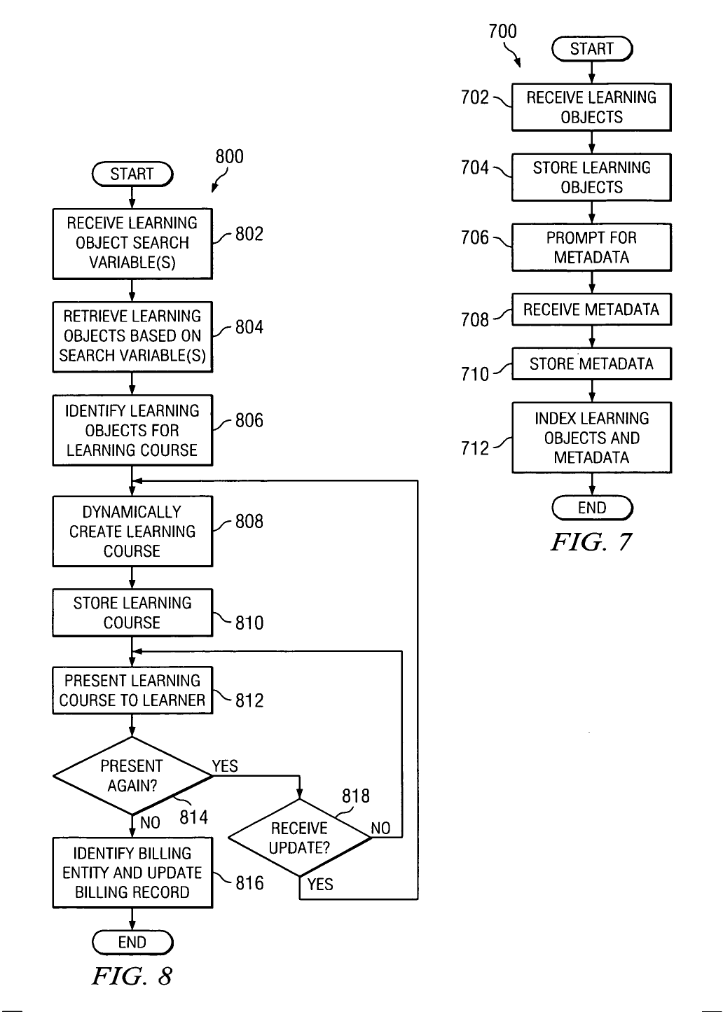

FIGS. 7 and 8 are flowcharts illustrating example methods, 700 and 800 respectively, for maintaining learning objects and the associated metadata and dynamically creating learning courses, respectively, in accordance with certain embodiments of the present disclosure. Generally, the following description focuses on the operation of the client within learning management system 140, perhaps using GUI 116 or content player 208, to perform these methods. Moreover, any reference to a particular implementation of the network-based application is meant to include the use of an API or other similar software or interface. But environment 100 contemplates using any appropriate combination and arrangement of logical elements implementing some or all of the described functionality. Indeed, any suitable environment, system, or component may implement the following or other similar techniques.

Method 700 begins at step 702 with the receipt of learning objects. For example, a user may use the authoring environment 210 to add (or import or upload) a learning object from content developer 106 or content provider 108, such as the BlackBerry learning object. At step 704, the learning objects are stored in the master repository. For example, the authoring environment 210 may store the learning objects in the learning content repository 220. In this implementation, the learning content 220 is located at the LMS 140 within the ERP system 135. In certain embodiments, developer 106 (or the user uploading the objects) is prompted for metadata associated with the learning objects at step 706. For example, the authoring environment 210 may prompt the developer for the value of a mandatory metadata field, as in GUI 500 of FIG. 5. Moreover, as described above, LMS 140 may automatically assign or default certain metadata to the learning object in addition to or in place of the developer's input. For example, LMS 140 may automatically assign a creation date based on the current system date, automatically determine an estimated completion time based on the amount of content files included or referenced in the learning object, assign the developer responsible for the learning object, default certain fields based on polices, and others.

At step 708, metadata associated with the learning objects is received from or updated by the user. For example, the authoring environment 210 provides the metadata editing area 506 where a content developer may maintain metadata associated with a learning object. In addition, the authoring environment 210 may maintain some metadata automatically, such as the creation date 518C, the author 518F, and the last edited date 518G. In some implementations, the authoring environment 210 allows metadata to be imported, such as from a file containing metadata associated with learning objects from a third party content provider. This file may be in any format, such as an extensible markup language (XML) format. The metadata is then stored at step 710. For example, the authoring environment 210 may store the metadata with the learning objects in the learning content 220. In other embodiments, this metadata may be stored separately and merely referenced by the particular learning object. Of course, this storage procedure may also include any verification or security functions as well. At step 712, the learning objects and the metadata may be indexed to provide more efficient subsequent access or review. For example, the authoring environment 210 may create an index of the learning objects and their associated metadata that provides fast access of the objects and metadata when performing searches by learners 104. The authoring environment 210 may store the index in the learning content repository 220 or any appropriate master index or other storage. In another embodiment, authoring environment 210 may instead inform an indexing server once new data is available for indexing. In this case, the indexing server would then perform updates or other processing on the appropriate index allowing it to be available to various (local or remote) authors 106 and learners 104. Regardless of the particular implementation, once the learning objects are stored or referenced in any suitable repository, then they may be accessed, search, or otherwise used by learners 104 to create or manage dynamic learning courses.

FIG. 8 illustrates such an example method 800 for dynamically creating a learning course. Method 800 begins at step 802 with the receipt of one or more learning object search variables via any suitable interface 116. For example, learner 104 may submit or select inputs using the example input controls 606-618 of FIGS. 6A-B to select search variable values. The learner 104 may send the search variables to the LMS 140 by selecting the find input control 620. In another example, learner 104 may input the search variables using content player 208, learning portal 204, or another interface. At step 804, learning objects are searched to retrieve or request a subset of the learning objects based on the one or more search variables received. For example, LMS 140 may perform a search of the learning content 220 using the search variables and present the results to the learner in the search results area 604. The search may also be performed at other components within the ERP system 135 or any other local or remote learning system.

In this example method, one or more learning objects within the subset of retrieved or received learning objects are identified as appropriate for learner 104. For example, the learner may make inputs using the selection controls 630A-D to identify learning objects relevant to the learner's needs. In another example, LMS 140 may automatically select or deselect learning objects based on the role of learner 104, requirements of the enterprise or department, updated content, completed objects, security concerns, and other criteria. While illustrated differently, this identification may occur concurrently with the search and retrieval. For example, LMS 140 may merely filter search results before collecting the references to them (or the actual objects themselves) to conserve bandwidth and reduce processing time. In another example, LMS 140 may collect only one learning object or a plurality of previously connected or related learning objects and identify these objects as relevant (or required) for the particular course.

At step 808, LMS 140 dynamically creates a learning course using the learning objects. Returning to the earlier example in FIG. 6B, the learner identified the learning objects 626A and 626B that the LMS 140 then uses to create a dynamic learning course. At step 810, the dynamic learning course is stored. For example, the learner 104 may select the save input control 622 to save the search variables used to determine the list of learning objects. Alternatively, learner 104 may select the save input control 636 to save the list of learning objects themselves. Regardless of the particular manual and/or automatic selection process, LMS 140 may create the learning course using any appropriate technique or components to logically tie, bundle, or otherwise couple various learning objects into the course. For example, LMS 140 may generate an XML file or other reference table that includes pointers to the various objects in the particular order. In another example, LMS 140 may instantiate a learning course object for the particular learner 104 that includes references or child objects for the learning to objects. In yet another example, LMS 140 may present the learning objects (or pointers thereto) to content player 208 for dynamic bundling of the various objects.

At step 812, the dynamically created learning course is presented to learner 104. For example, LMS 140 may present the course to the learner using the content player 208. At step 814, if the learner 104 is finished reviewing the course, then method 800 proceeds to step 816 where a billing entity associated with the learner 104 may be identified and a billing record of the billing entity updated based on the dynamic learning course or one or more of the component objects. This example billing procedure is for example purposes only. In other implementations, LMS 140 may not bill upon completion, but may instead not bill at all, bill upon selection, bill upon creation, or bill as individual objects are completed. Otherwise, if learner 104 selects the course for presentation again, then method 800 proceeds to step 818. At step 818, if no updates to the learning objects (or the learning object selection) have been made, then method 800 returns to step 812 where the dynamic learning course is presented again. Otherwise, if the content of the learning objects has been updated or the selection of learning objects has changed, then method 800 returns to step 808 where the learning course is dynamically generated again. In other embodiments, LMS 140 may dynamically update the learning course “on the fly” instead of recreating the course. Indeed, this dynamic updating may even occur while learner 104 is progressing through the particular course. For example, LMS 140 may monitor the learning objects in the in-progress course for updates or newer versions or objects; then, if an update to an incomplete object is identified, then LMS 140 may automatically update the course or ask for verification from learner 104.

The preceding flowcharts and accompanying descriptions illustrate exemplary methods 700 and 800. But environment 100 contemplates using any suitable technique for performing these and other tasks. Accordingly, many of the steps in these flowcharts may take place simultaneously and/or in different orders than as shown. Moreover, environment 100 may use methods with additional steps, fewer steps, and/or different steps, so long as the methods remain appropriate. For example, it will be understood that the client may execute portions of the processes described in methods 700 and 800 in parallel or in sequence.

A number of embodiments have been described. Nevertheless, it will be understood that various modifications may be made without departing from the spirit and scope of the disclosure. For example, while described herein as being implemented in a learning management system, the components and techniques may be used in any similar or dissimilar application, module, or web service. Moreover, it is not required that the client and server reside within the same.

What is claimed is:

1. Method for dynamic learning courses comprising:
searching a plurality of learning objects to retrieve a subset of the plurality based on at least one search variable;
identifying a first learning object from the subset;
identifying a second learning object from the subset; and
dynamically creating a learning course using at least the first and second learning objects.

2. The method of claim 1, the first learning object referenced in a first static learning course.

3. The method of claim 2, the first learning object referenced in a second static learning course.

4. The method of claim 2, the second learning object referenced in a second static learning course.

5. The method of claim 1, wherein the learning objects are remotely stored and the dynamic learning course is created at a client.

6. The method of claim 1, the one or more search variables received from a learner via browser.

7. The method of claim 6, further comprising:
identifying a billing entity associated with the learner; and
updating at least one billing record of the billing entity based on the dynamic learning course.

8. The method of claim 6, further comprising:
identifying a role of the learner; and
defaulting one of the search criteria in the browser based on the identified role.

9. The method of claim 6, further comprising:
identifying a role of the learner; and
limiting the search of the plurality of learning objects based on security policies associated with the role.

10. The method of claim 1, wherein searching the plurality of learning objects to retrieve a subset comprises comparing each search variable to metadata of the particular learning object.

11. The method of claim 10, the metadata comprising a description, a title, a creation date, an estimated completion time, and one or more key words.

12. The method of claim 10, further comprising:
automatically retrieving a new subset of the plurality of learning objects based on at least one component of the metadata, the new subset comprising at least the first learning object; and
automatically recreating the learning course based on the new subset of learning objects.

13. The method of claim 12, the metadata comprising a time range and wherein automatically retrieving a new subset comprises retrieving a third learning object as part of the subset based on the metadata and filtering the second learning object based on the metadata.

14. The method of claim 1, further comprising:
identifying a new version of the first learning object after the dynamic learning course is created; and
automatically updating the dynamic learning course using the new version.

15. The method of claim 1, further comprising limiting the retrieval of the subset of learning objects to those objects not previously completed by a learner.

16. A system comprising:
means for searching a plurality of learning objects to retrieve a subset of the plurality based on at least one search variable;
means for identifying a first learning object from the subset;
means for identifying a second learning object from the subset; and
means for dynamically creating a learning course using at least the first and second learning objects.

17. Software for dynamic learning courses operable to:
search a plurality of learning objects to retrieve a subset of the plurality based on at least one search variable;
identify a first learning object from the subset;
identify a second learning object from the subset; and
dynamically create a learning course using at least the first and second learning objects.

18. The software of claim 17, the first learning object referenced in a first static learning course.

19. The software of claim 18, the first learning object referenced in a second static learning course.

20. The software of claim 18, the second learning object referenced in a second static learning course.

21. The software of claim 17, wherein the learning objects are remotely stored and the dynamic learning course is created at a client.

22. The software of claim 17, the one or more search variables received from a learner via browser.

23. The software of claim 22, further operable to:
identify a billing entity associated with the learner; and
update at least one billing record of the billing entity based on the dynamic learning course.

24. The software of claim 22, further operable to:
identify a role of the learner; and
default one of the search criteria in the browser based on the identified role.

25. The software of claim 22, further operable to:
identify a role of the learner; and
limit the search of the plurality of learning objects based on security policies associated with the role.

26. The software of claim 17, wherein the software operable to search the plurality of learning objects to retrieve a subset comprises software operable to compare each search variable to metadata of the particular learning object.

27. The software of claim 26, the metadata comprising a description, a title, a creation date, an estimated completion time, and one or more key words.

28. The software of claim 26, further operable to:
automatically retrieve a new subset of the plurality of learning objects based on at least one component of the metadata, the new subset comprising at least the first learning object; and
automatically recreate the learning course based on the new subset of learning objects.

29. The software of claim 28, the metadata comprising a time range and wherein automatically retrieving a new subset comprises retrieving a third learning object as part of the subset based on the metadata and filtering the second learning object based on the metadata.

30. The software of claim 17, further operable to:
identify a new version of the first learning object after the dynamic learning course is created; and
automatically update the dynamic learning course using the new version.

31. The software of claim 17, further operable to limit the retrieval of the subset of learning objects to those objects not previously completed by a learner.

32. A system for dynamic learning courses, comprising:
memory storing a plurality of learning objects; and
one or more processors operable to:
search the plurality of learning objects to retrieve a subset of the plurality based on at least one search variable;
identify a first learning object from the subset;
identify a second learning object from the subset; and
dynamically create a learning course using at least the first and second learning objects.

33. The system of claim 32, the first learning object referenced in a first static learning course.

34. The system of claim 33, the first learning object referenced in a second static learning course.

35. The system of claim 33, the second learning object referenced in a second static learning course.

36. The system of claim 32, wherein the learning objects are remotely stored and the dynamic learning course is created at a client.

37. The system of claim 32, the one or more search variables received from a learner via browser.

38. The system of claim 37, wherein the one or more processors further operable to:
identify a billing entity associated with the learner; and
update at least one billing record of the billing entity based on the dynamic learning course.

39. The system of claim 37, wherein the one or more processors further operable to:
identify a role of the learner; and
default one of the search criteria in the browser based on the identified role.

40. The system of claim 37, the one or more processors further operable to:
identify a role of the learner; and
limit the search of the plurality of learning objects based on security policies associated with the role.

41. The system of claim 32, wherein the one or more processors operable to search the plurality of learning objects to retrieve a subset comprises the one or more processors operable to compare each search variable to metadata of the particular learning object.

42. The system of claim 41, the metadata comprising a description, a title, a creation date, an estimated completion time, and one or more key words.

43. The system of claim 41, the one or more processors further operable to:
automatically retrieve a new subset of the plurality of learning objects based on at least one component of the metadata, the new subset comprising at least the first learning object; and
automatically recreate the learning course based on the new subset of learning objects.

44. The system of claim 43, the metadata comprising a time range and wherein automatically retrieving a new subset comprises retrieving a third learning object as part of the subset based on the metadata and filtering the second learning object based on the metadata.

45. The system of claim 32, the one or more processors further operable to:
identify a new version of the first learning object after the dynamic learning course is created; and
automatically update the dynamic learning course using the new version.

46. The system of claim 32, the one or more processors further operable to limit the retrieval of the subset of learning objects to those objects not previously completed by a learner.
